(19) United States
(12) Patent Application Publication
(10) Pub. No.: US 2024/0270572 A1
(43) Pub. Date: Aug. 15, 2024

(54) A METHOD FOR PRODUCING SYNGAS USING CATALYTIC REVERSE WATER GAS SHIFT

(71) Applicant: SHELL USA, INC., Houston, TX (US)

(72) Inventors: Ronald Jan SCHOONEBEEK, Amsterdam (NL); Dominik Johannes Michael UNRUH, Amsterdam (NL); Alouisius Nicolaas Renée BOS, Amsterdam (NL)

(21) Appl. No.: 18/568,828

(22) PCT Filed: Jun. 13, 2022
(86) PCT No.: PCT/EP2022/066053

§ 371 Date: Dec. 10, 2023

(30) Foreign Application Priority Data
Jun. 14, 2021 (EP) 21179276.7

(51) Int. Cl. C01B 3/16; B01D 53/14; C01B 3/52

(52) U.S. Cl. CPC C01B 3/16; B01D 53/1475; C01B 3/52; B01D 2252/204; B01D 2256/16; B01D 2257/504; C01B 2203/0475; C01B 2203/0495; C01B 2203/0805; C01B 2203/0883; C01B 2203/148

(57) ABSTRACT

The present invention relates to a method for producing syngas using a catalytic reverse water gas shift (RWGS) reaction, the method at least comprising the steps of: a) providing a feed stream (10) comprising at least hydrogen (H2) and carbon dioxide (CO2); b) heating the feed stream (10) provided in step a) in a first heat exchanger (3) thereby obtaining a first heated feed stream (20); c) introducing the first heated feed stream (20) into a RWGS reactor (2) and subjecting it to a catalytic RWGS reaction, thereby obtaining a syngas containing stream (30); d) cooling the syngas containing stream (30) obtained in step c) in the first heat exchanger (3) against the feed stream (10) provided in step a), thereby obtaining a first cooled syngas stream (40); c) cooling the first cooled syngas stream (40) obtained in step d) in a second heat exchanger (5) thereby obtaining a second cooled syngas stream (50); f) separating the second cooled syngas stream (50) obtained in step e) in a gas/liquid separator (6) thereby obtaining a water-enriched stream (110) and a water-depleted syngas stream (100); g) separating the water-depleted syngas stream (100) obtained in step f) in a CO₂ removal unit (8) thereby obtaining a CO₂-enriched stream (120) and a CO₂-depleted syngas stream (130): and—31−h) combining the CO₂-enriched stream (120) obtained in step g) with the feed stream (10) provided in step a).

The present invention relates to a method for producing syngas using a catalytic reverse water gas shift (RWGS) reaction.

Methods for producing syngas using RWGS are known. RWGS reactions convert carbon dioxide (CO₂) and hydrogen (H₂) into ‘syngas’, which contains at least carbon monoxide (CO) and hydrogen (H₂), and typically also water (H₂O) and unconverted carbon dioxide (CO₂) . RWGS reactions are endothermic in nature; hence, it is necessary to supply sufficient thermal energy to the reactants (i.e. carbon dioxide and hydrogen) to facilitate the endothermic RWGS reaction.

The RWGS reaction is in fact the backward reaction of the equilibrium of the ‘water gas shift’ (WGS) reaction, which is a well-known reaction to convert carbon monoxide and water to carbon dioxide and hydrogen. The RWGS reaction can proceed without the use of a catalyst, but this requires very high temperatures (e.g. 1000° C. or even much higher) favoring both the kinetics and maximum achievable equilibrium conversions.

If a catalyst for the RWGS reaction is used, much lower temperatures may be required for the reaction to proceed and the reaction conditions and catalyst used are to be selected such that the catalyzation of the very exothermic methanation reaction (CO₂+4H₂→CH₄+2H₂O) is avoided or at least minimized. The thermodynamics may drive the reaction towards methanation (rather than towards RWGS) and too low temperatures may severely lower the equilibrium conversion of RWGS itself, so finding reaction conditions and a catalyst resulting in acceptable conversion of CO₂ to syngas with non-methanation or very low methanation is a key challenge.

Currently, the status of developments regarding the RWGS reaction have been mostly on lab-scale. There is still a lot to explore until large-scale RWGS will be a commercially attractive option.

For large-scale conversion of carbon dioxide there is a need to be able to more efficiently and economically carry out the RWGS reaction. In achieving high conversion of carbon dioxide selectively to carbon monoxide, by-products like methane and carbon formation are to be avoided. Also, the amount of energy input required for performing the endothermic RWGS reaction requires attention.

As a mere example of a recently published RWGS method, WO2020114899A1 discloses a method for producing syngas using a RWGS reaction, wherein no catalyst is present in the reaction vessel and the temperature in the reaction vessel is maintained in the range of 1000 to 1500° C.

A problem of the above method is that relatively high temperatures are used to perform the RWGS reaction which requires the use of high temperature resistant materials in the reaction vessel, synthesis gas coolers or feed effluent heat exchangers.

Another problem of the above method is that a relatively high energy input is required to perform the (endothermic) RWGS reaction and to heat up the feed stream to the reaction temperature, i.e. achieving a high energy efficiency is a challenge.

As another example of a recently published RWGS method, WO2021062384A1 discloses a multi-step RWGS process. As taught in paragraph [0007] of this publication, “recycle of products from the product stream back to the RWGS reactor creates several complexities and drawbacks”.

As another example of a RWGS method, WO2008115933A1 discloses a process for renewable hydrocarbons and oxygenates that combines two steps: (1) a Renewable CO Production (RCOP) step where a mixture of CO and H₂ is produced and (2) a Fischer-Tropsch synthesis section where (after further addition of hydrogen) the desired end products are made. The problem with this process is that the latter step is needed because this RWGS section in the RCOP step can only produce syngas with a hydrogen to CO ratio up to 1.4, otherwise there is excessive methanation. More commonly in their process the H₂/CO ratio is significantly below 1.0; nearly all examples disclosed in this prior art shows H₂/CO ratios below 0.7. Moreover, this process of the prior art teaches to apply pressures preferably below 10 bar pressure and temperatures below 450° C. to suppress methanation. Hence the RWGS reactor in this prior art process operates at relatively unfavorable conditions, allowing for only low conversions per pass. Consequently, the overall process of WO2008115933A1 is rather complex and capital intensive.

In contrast, it is one of the advantages of the present invention to allow operating at more elevated pressures and temperatures and to produce a syngas with a H₂/CO ratio around 2.0, with less than 1% methane, so it can be directly used as feed for a conventional Fischer-Tropsch process, or even relatively higher so it can be directly used for methanol synthesis.

As another example of a RWGS method, WO2007108014A1 discloses a process for producing liquid hydrocarbon products from H₂ and CO₂ including a generic RWGS step. However, this prior art does not teach or disclose any details or advantages of the RWGS step.

As another example of a RWGS process, WO2021062384A1 discloses a process for producing liquid hydrocarbon products from H₂ and CO₂ including a RWGS step with two (or more) reactors in series. Notably, the last of the reactors in series is “fired”, i.e. the heat is provided via burning of a fuel on the outside of tubes filled with catalyst. In case a hydrocarbon is used as fuel, the CO₂ produced and present in the exhaust is recycled to the RWGS reactors.

In contrast, it is one of the advantages of the present invention to allow operating at relatively lower temperatures, allowing for high efficiencies whilst preventing high skin temperatures present in fired reactors.

It is an object of the present invention to minimize one or more of the above problems identified in the prior art.

It is a further object of the present invention to provide a method for producing syngas using a catalytic RWGS reaction that can be performed at lower temperatures, preferably lower than 700° C., whilst still achieving a high (>90%) overall CO₂ conversion. It is an even further object of the present invention to provide a method for producing syngas using a single-stage catalytic RWGS reaction.

One or more of the above or other objects can be achieved by providing a method for producing syngas using a catalytic reverse water gas shift (RWGS) reaction, the method at least comprising the steps of:
a) providing a feed stream comprising at least hydrogen (H₂) and carbon dioxide (CO₂);
b) heating the feed stream provided in step a) in a first heat exchanger thereby obtaining a first heated feed stream;
c) introducing the first heated feed stream into a RWGS reactor and subjecting it to a catalytic RWGS reaction, thereby obtaining a syngas containing stream;
d) cooling the syngas containing stream obtained in step c) in the first heat exchanger against the feed stream provided in step a), thereby obtaining a first cooled syngas stream;
e) cooling the first cooled syngas stream obtained in step d) in a second heat exchanger thereby obtaining a second cooled syngas stream;
f) separating the second cooled syngas stream obtained in step e) in a gas/liquid separator thereby obtaining a water-enriched stream and a water-depleted syngas stream;
g) separating the water-depleted syngas stream obtained in step f) in a CO₂ removal unit thereby obtaining a CO₂-enriched stream and a CO₂-depleted syngas stream; and
h) combining the CO₂-enriched stream obtained in step g) with the feed stream provided in step a).

It has surprisingly been found according to the present invention that even though the RWGS reaction is performed at relatively low temperatures (such as below 700° C.), a desirable overall conversion of CO₂ (whilst comparing the CO₂ content of the feed stream of step a) with the CO₂ content of the CO₂-depleted stream obtained in step g)) of above 90% or even above 95% may be achieved, whilst minimizing carbon formation and/or methanation (methane formation) even though the latter two are thermodynamically favoured.

An important advantage of the present invention is that less expensive materials need to be used for e.g. the reactors, heaters and heat exchangers in view of the lower temperatures being used which alleviates materials problems related to the nature of the gas stream (e.g. metal dusting, methanation, etc.).

A further advantage of the present invention is that the RWGS reaction can be performed in a single stage (i.e. only one RWGS reactor being present).

Also, commercially available heated reactors (e.g. using multi-tubular molten salt reactors can be used for the heating required in the endothermic RWGS reaction.

A further advantage of the present invention is that it allows for flexibility in the CO/H₂ ratio of the obtained syngas product stream. Dependent on the use of the syngas product stream (such as production of methanol or DME (dimethyl ether), use in Fischer-Tropsch reaction, etc.), the CO/H₂ ratio can be easily adapted.

In step a) of the method according to the present invention a feed stream is provided comprising at least hydrogen (H₂) and carbon dioxide (CO₂).

The person skilled in the art will readily understand that the feed stream is not particularly limited and may come from various sources. Typically, the feed stream comprises 60-80 vol. % H₂, preferably 65-75 vol. % H₂, and typically 20-40 vol. % CO₂, preferably 25-35 vol. % CO₂. Other components such as CH₄, CO, H₂O, C2+, C=2+, N₂, Ar, O₂, sulphur components (such as H₂S, mercaptans, COS, SO₂) and nitrogen compounds (such as NOx, NH₃) may be present. Also, the feed stream may contain small amounts of sorbent (such as amines, KOH, MeOH, glycols, etc.), e.g. as used in DAC [Direct Air Capture]) or other CO₂ removal units.

Generally, the feed stream has a hydrogen to carbon dioxide (H₂/CO₂) volume ratio of between 2.5 and 5, typically between 2.5 and 3.0. The H₂/CO₂ volume ratio of hydrogen to carbon dioxide can be adjusted such that the required hydrogen to carbon monoxide ratio in the eventual product stream is obtained. Further, please note that the H₂/CO₂ volume ratio of the feed stream is subsequently lowered by the combination of the feed stream provided in step a) with the CO₂-enriched stream obtained in step g).

Generally, the feed stream has a temperature of 5-150° C. and, preferably above 20° C. The feed stream typically has a pressure in the range of from 1 to 200 bara. Preferably, the pressure is from 5 to 70 bara.

In step b) of the method according to the present invention, the feed stream provided in step a) is heated (by indirect heat exchange) in a first heat exchanger thereby obtaining a first heated feed stream.

Typically, the first heated feed stream has a temperature of 200-700° C., preferably 450-600° C. The person skilled in the art will readily understand that in addition to the first heat exchanger, further heat exchangers may be present; such further heat exchangers may form part of the overhead of the RWGS reactor. Preferably, the first heated stream obtained in step b) has a hydrogen to carbon dioxide (H₂/CO₂) volume ratio of below 2.0, preferably below 1.5, more preferably below 1.2.

Please note in this respect that the H₂/CO₂ volume ratio of the first heated stream is lower than the H₂/CO₂ volume ratio of the feed stream, in view of the combination of the feed stream provided in step a) with the CO₂-enriched stream obtained in step g). This combination of the feed stream provided in step a) with the CO₂-enriched stream obtained in step g) occurs before the heating in step b).

In step c) of the method according to the present invention, the first heated feed stream is introduced into a RWGS reactor and subjected to a catalytic RWGS reaction, thereby obtaining a syngas containing stream.

As the person skilled in the art is familiar with RWGS reactors and conditions of catalytic RWGS reactions, this is not discussed here in detail.

Typical temperatures of the catalytic RWGS reaction in the RWGS reactor are 450-700° C., preferably above 500° C. The person skilled in the art will understand that the temperature may vary over the reactor (e.g. higher at the inlet than at the outlet, in particular for an adiabatic process) . Preferably, the temperature of the catalytic RWGS reaction in step c) is kept below 700° C., preferably below 600° C.

As, the RWGS reaction is endothermic, heating needs to be provided to the reactor. This heating may come from any source, e.g. indirectly via heating by molten salt circulating around the individual tubes of a multi-tubular reactor wherein the circulating molten salt itself is heated by electrical heating, preferably in counter-current mode, or directly via the feed stream in the case of an adiabatic process.

Typical pressures as used in the RWGS reactor are 1-200 bara, preferably above 20 bara and preferably below 70 bara. Further, typical gas hourly space velocities (GHSV) are 500-100,000 h⁻¹, preferably above 3,000 h⁻¹ and preferably below 10,000 h⁻¹.

In the RWGS reactor a catalytic RWGS reaction takes place and this requires the presence of a catalyst. Typically, the RWGS reactor contains a catalyst bed. As the person skilled in the art is familiar with suitable RWGS beds and catalysts, this is not discussed here in detail. Preferably, the catalyst bed comprises a catalyst that is suitable for performing a RWGS reaction below 700° C. Further it is preferred that the catalyst does not promote methanation under the used conditions. Preferred examples of suitable ‘non-methanation promoting’ catalysts comprise at least cerium oxide, zirconium oxide, or a combination thereof. The catalyst may contain further components in addition to the cerium oxide and/or zirconium oxide.

According to a preferred embodiment of the present invention, the RWGS reactor contains two or more catalyst beds with additional intermediate heating between the two or more catalyst beds. The two or more catalyst beds within the RWGS reactor may contain the same or different catalysts.

According to a further preferred embodiment, the RWGS reactor comprises a multi-tubular reactor heated by molten salt circulating around the tubes of the multi-tubular reactor. In this embodiment, the molten salt provides for the heat required for the endothermic reaction as taking place in the multi-tubular reactor. Preferably, the molten salt is circulating in counter-current mode around the tubes of the multi-tubular reactor (when compared to the fluid flow in the tubes of the reactor) . The circulating molten salt is preferably heated from outside the reactor. Preferably, each of the tubes of the multi-tubular reactor comprises a catalyst.

As a result of the RWGS reaction in step c), a syngas containing stream is obtained, at least comprising hydrogen (H₂) and carbon monoxide (CO). Typically, the syngas containing stream also contains water (H₂O) and unconverted carbon dioxide (CO₂). Typically, the amounts of components in the first syngas containing stream are around thermodynamic equilibrium concentrations of the RWGS reaction.

Generally, the syngas containing stream has a hydrogen to carbon monoxide (H₂/CO) volume ratio in the range of 1.5 to 10, preferably below 5.0, more preferably below 2.5.

One of the advantages of the present invention is that the used RWGS reaction results in low methanation (methane formation). Preferably, the syngas containing stream comprises at most 1.0 vol. % methane (CH₄) , preferably at most 0.1 vol. % methane.

Preferably, the temperature of the syngas containing stream obtained in step c) (at the outlet of the RWGS reactor) is kept below 700° C., preferably below 650° C., more preferably below 600° C. and typically above 450° C.

In step d) of the method according to the present invention, the syngas containing stream obtained in step c) is cooled in the heat exchanger against the feed stream provided in step a), thereby obtaining a first cooled syngas stream.

Typically, the first cooled syngas stream has a temperature of 80-250° C. and, preferably below 170° C.

In step e) of the method according to the present invention, the first cooled syngas stream obtained in step d) is cooled in a second heat exchanger thereby obtaining a second cooled syngas stream.

Typically, the second cooled syngas stream has a temperature of 20-80° C. and, preferably below 60° C.

In step f) of the method according to the present invention, the second cooled syngas stream obtained in step e) is separated in a gas/liquid separator thereby obtaining a water-enriched stream and a water-depleted syngas stream.

Typically, the amounts of components in the water-depleted syngas stream are around thermodynamic equilibrium concentrations. Typically, the water-depleted syngas stream comprises at most 5 vol. % H₂O, preferably at most 1 vol. % H₂O.

In step g) of the method according to the present invention, the water-depleted syngas stream obtained in step f) is separated in a CO₂ removal unit thereby obtaining a CO₂-enriched stream and a CO₂-depleted syngas stream.

As the person skilled in the art is familiar with CO₂ removal units, this is not further discussed here in detail. Suitable CO₂ removal units are adsorption units, absorption units, etc. Preferably, the CO₂ removal unit comprises an absorption unit, preferably an amine absorption unit.

The CO₂-depleted syngas stream may be further processed and/or used as a product stream.

Preferably, the CO₂-depleted syngas stream obtained in step g) comprises at most 10 vol. % CO₂, preferably at most 5 vol. % CO₂, more preferably at most 2 vol. % CO₂.

Typically, the CO₂-depleted syngas stream obtained in step g) has a hydrogen to carbon monoxide (H₂/CO) volume ratio in the range of 0.5 to 5. Preferably, the CO₂-depleted syngas stream obtained in step g) has a hydrogen to carbon monoxide (H₂/CO) volume ratio in the range of 1.5 to 2.5; the latter range makes this stream very suitable as a syngas stream for e.g. production of methanol or DME or for use in Fischer-Tropsch reactions.

The CO₂-enriched stream obtained in step g) comprises at least 90 vol. % CO₂, preferably at least 95 vol. % CO₂, more preferably at least 99 vol. % CO₂. The CO₂-enriched stream typically also contains some minor amounts of H₂, CO and H₂O.

In step h) of the method according to the present invention, the CO₂-enriched stream obtained in step g) is combined with the feed stream provided in step a).

In a further aspect, the present invention provides an apparatus suitable for performing the method for producing syngas according to the present invention, the apparatus at least comprising:
a heat exchanger for heat exchanging the feed stream against the syngas containing stream removed from the RWGS reactor, to obtain a first heated feed stream and a first cooled syngas stream;
a RWGS reactor for subjecting the first heated feed stream to a catalytic RWGS reaction to obtain a syngas containing stream;
a second heat exchanger for heat exchanging the first cooled syngas stream, to obtain a second cooled syngas stream;
a gas/liquid separator for separating the second cooled syngas stream to obtain a water-enriched stream and a water-depleted syngas stream;
a CO₂ removal unit to obtain a CO₂-enriched stream and a CO₂-depleted syngas stream;

wherein the apparatus is configured to combine the CO₂-enriched stream obtained in the CO₂ removal unit with the feed stream.

Preferably, the apparatus according to the present invention is a ‘single stage’ RWGS apparatus, i.e. wherein only one RWGS reactor is used.

Preferably, the RWGS reactor contains two or more catalyst beds with additional intermediate heating between the two or more catalyst beds.

Further it is preferred that the RWGS reactor comprises a multi-tubular reactor heated by a molten salt circulating around the tubes of the multi-tubular reactor.

Hereinafter the present invention will be further illustrated by the following non-limiting drawings. Herein shows:

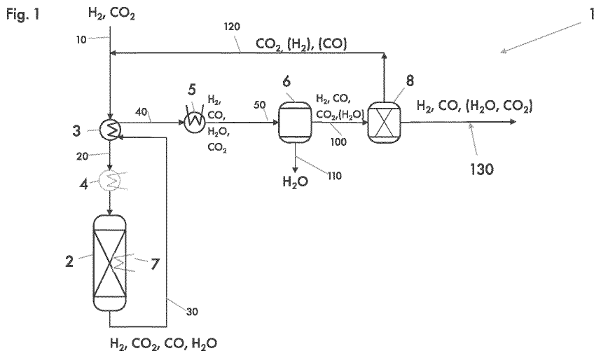

FIG. 1 schematically a first embodiment of an apparatus suitable for performing the method for producing syngas using a catalytic RWGS reaction according to the present invention; and

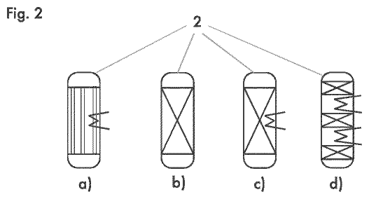

FIG. 2 schematically examples of different reactor types that can be used for the RWGS reactor as used according to the present invention.

For the purpose of this description, same reference numbers refer to same or similar components.

The apparatus of FIG. 1, generally referred to with reference number 1, comprises a RWGS reactor 2, a first heat exchanger 3, a second heat exchanger 5, a further heat exchanger 4 and a first gas/liquid separator 6 (in the form of a H₂O knock-out drum) and a CO₂ removal unit 8.

In the embodiment of FIG. 1, the RWGS reactor 2 comprises a catalyst bed and is provided with external heating 7 (e.g. in the form of electrical heating or molten salt heater).

The heat exchangers 3, 4 and 5 may be integrated with the external heating 7.

During use, a feed stream 10 is provided, which comprises at least hydrogen (H₂) and carbon dioxide (CO₂).

The feed stream is heated in the first heat exchanger 3 thereby obtaining a first heated feed stream 20. As shown in the embodiment of FIG. 1, the heated feed stream 20 may be further heated in a further heat exchanger 4. This further heat exchanger 4 may form part of the (overhead of the) RWGS reactor 2.

The first heated feed stream 20 is introduced into the RWGS reactor 2 and subjected to a catalytic RWGS reaction, thereby obtaining a syngas containing stream, which is removed as stream 30 from the RWGS reactor 2.

Then, the syngas containing stream 30 is cooled in the first heat exchanger 3 by indirect heat exchange against the feed stream 10, thereby obtaining a first cooled syngas stream 40. The first cooled syngas stream 40 is further cooled in the second heat exchanger 5, thereby obtaining a second cooled syngas stream 50.

Subsequently, the second cooled syngas stream 50 is separated in the gas/liquid separator 6 thereby obtaining a water-enriched stream 110 and a water-depleted syngas stream 100.

The water-depleted syngas stream 100 is then separated in the CO₂ removal unit, thereby obtaining a CO₂-enriched stream 120 and a CO₂-depleted syngas stream 130. Stream 130 can be further processed or used as a product stream.

The CO₂-enriched stream 120 is combined with the feed stream 10.

FIG. 2 shows schematically non-limiting examples of different reactor types that can be used for the RWGS reactor in the apparatus 1 according to the present invention.

The reactor of FIG. 2a) comprises a multi-tubular reactor heated by a molten salt circulating around the tubes of the multi-tubular reactor. Preferably, the molten salt flow inside the shell of the multi-tubular reactor is counter-currently when compared to the flow of the gas inside the tubes. As shown, the molten salt may be heated by separate external heating, preferably an e-heater. If molten salt is used for two or more reactors, then there may be a common circuit for the molten salt.

The reactor of FIG. 2b) comprises a single catalyst bed, whilst the reactor of FIG. 2c) comprises a single catalyst bed provided with external heating. In FIG. 1 the reactor of the type shown in FIG. 2c) is used.

Further, the reactor of FIG. 2d comprises 3 catalyst beds with intermediate external heating between the beds.

Generally, if any of the reactors of 2b)-d) is used, then preheating (as in heat exchangers 4) is preferred.

### EXAMPLES

### Example 1

The apparatus of FIG. 1 was used for illustrating an exemplary method according to the present invention. The compositions and conditions of the streams in the various flow lines are provided in Table 1 below.

The values in Table 1 were calculated using a model generated with commercially available UniSim software, whilst using an ‘equilibrium reactor’ with settings such that only the (R) WGS reactions are allowed to occur and whilst arranging the settings such that no methanation occurred (hence 0 vol % CH₄ in all streams) . Thus, the standard ‘Gibbs model’ was not used, which model would predict excess methanation (which does not occur or is at least minimized according to the present invention). Further, for the CO₂ removal unit 8 a CO₂ removal efficiency of 98% was assumed (this value of 98% is realistic; there are CO₂ removal units that come close to an efficiency of 100%).

As can be seen from Table 1 below, an overall CO₂ conversion of 97% was achieved, whilst aiming for a H₂/CO ratio of 1.9, which ratio is e.g. suitable for subsequent Fischer-Tropsch reaction or production of methanol.

TABLE 1

| stream | 10 | 20 | 30 | 40 | 50 | 100 | 110 | 120 | 130 |
|---|---|---|---|---|---|---|---|---|---|
| T [° C.] | 25 | 480 | 550 | 153 | 40 | 40 | 40 | 40 | 40 |
| CO₂ | 26.3 | 49.1 | 31.6 | 31.6 | 31.6 | 38.2 | — | 100 | 1.2 |
| [vol. %] | | | | | | | | | |
| H₂ | 73.7 | 50.9 | 33.4 | 33.4 | 33.4 | 40.4 | — | — | 64.5 |
| [vol. %] | | | | | | | | | |
| CO | 0 | 0 | 17.5 | 17.5 | 17.5 | 21.1 | — | — | 33.7 |
| [vol. %] | | | | | | | | | |
| H₂O | 0 | 0 | 17.5 | 17.5 | 17.5 | 0 | 100 | — | — |
| [vol. %] | | | | | | | | | |
| H₂/CO₂ | 2.8 | 1 | 1.1 | 1.1 | 1.1 | 1.1 | — | — | — |
| H₂/CO | — | — | 1.9 | 1.9 | 1.9 | 1.9 | — | — | 1.9 |
| XCO₂¹ [%] | — | — | 36 | 36 | 36 | 36 | — | — | 97 |

¹XCO₂ = % conversion of CO₂, based on feed stream 10.

### Example 2 (Comparative)

For comparison with FIG. 1, a set of calculations was performed for the line-up of FIG. 1 and with the same composition for feed stream 10 (with a H₂/CO₂ ratio of 2.8), but without combining the CO₂-enriched stream 120 (as obtained in CO₂ removal unit 8) with the feed stream 10. The same UniSim software as used in Example 1 was used.

Table 2 shows the compositions and conditions of the streams in the various flow lines.

As can be seen from Table 2, the line-up of FIG. 1 without combining the CO₂-enriched stream 120 (as obtained in CO₂ removal unit 8) with the feed stream 10 resulted in a relatively low CO₂ conversion (54%) when compared to the line-up of FIG. 1 according to the present invention (97% for stream 130) where stream 120 was combined with the feed stream 10.

Further, due to the much lower conversion, the H₂/CO ratio of the syngas product stream 130 is much higher than for Example 1 (viz. 4.1 vs 1.9). This higher H₂/CO ratio is also much higher than the preferred range for subsequent use in Fischer-Tropsch or typical methanol or DME synthesis.

TABLE 2
Comparative - with CO₂ removal unit 8, but no recycle.

| stream | 10 | 20 | 30 | 40 | 50 | 100 | 110 | 120 | 130 |
|---|---|---|---|---|---|---|---|---|---|
| T [° C.] | 25 | 480 | 550 | 149 | 40 | 40 | — | — | 40 |
| CO₂ | 26.3 | 26.3 | 12.0 | 12.0 | 12.0 | 13.9 | — | 100 | 0.3 |
| [vol. %] | | | | | | | | | |
| H₂ | 73.7 | 73.7 | 59.4 | 59.4 | 59.4 | 69.1 | — | — | 80.3 |
| [vol. %] | | | | | | | | | |
| CO | 0 | 0 | 14.3 | 14.3 | 14.3 | 16.7 | — | — | 19.4 |
| [vol. %] | | | | | | | | | |
| H₂O | 0 | 0 | 14.3 | 14.3 | 14.3 | 0 | 100 | — | 0 |
| [vol. %] | | | | | | | | | |
| H₂/CO₂ | 2.8 | 2.8 | 5.0 | 5.0 | 5.0 | 5.0 | — | — | — |
| H₂/CO | — | — | 4.1 | 4.1 | 4.1 | 4.1 | — | — | 4.1 |
| XCO₂¹ [%] | — | — | 54 | 54 | 54 | 54 | — | — | 54 |

¹XCO₂ = % conversion of CO₂, based on feed stream 10.

### Example 3 (Comparative)

For further comparison with the present invention (again using the same UniSim software), a set of calculations was performed for the line-up of FIG. 1 with the same composition for the feed stream 10 (with a H₂/CO₂ ratio of 2.8), but without the presence of the CO₂ removal unit 8 (and hence also without combining the CO₂-enriched stream 120 as obtained in a CO₂ removal unit 8 with the feed stream 10).

Table 3 shows the compositions and conditions of the streams in the various flow lines. The results are similar as for Example 2, except that most of the CO₂ has now not been removed for the final syngas product stream (in this case stream 100) thereby diluting the syngas without changing the overall conversion of CO₂ (54%) or the H₂/CO ratio (4.1) in the product stream 100. Hence, also for Example 3, both CO₂ conversion and H₂/CO ratio of the syngas product stream compare very unfavourable to Example 1.

As in Table 2, the overall CO₂ conversion for stream 100 in Table 3 is again relatively low. As can be seen from Table 3, the H₂/CO ratio (viz. 4.1) for the water-depleted syngas stream 100 was a lot higher than for Table 1 (viz. 1.9). Such a high H₂/CO ratio would make the stream virtually unsuitable for use in the main target applications (such as in Fischer-Tropsch reactions or reactions to obtain methanol or DME).

TABLE 3
Comparative - no CO₂ removal unit 8. Same H₂/CO₂ ratio for feed stream 10

| stream | 10 | 20 | 30 | 40 | 50 | 100 | 110 | 120 | 130 |
|---|---|---|---|---|---|---|---|---|---|
| T [° C.] | 25 | 480 | 550 | 149 | 40 | 40 | 40 | N.A. | N.A. |
| CO₂ | 26.3 | 26.3 | 12.0 | 12.0 | 12.0 | 13.9 | — | N.A. | N.A. |
| [vol. %] | | | | | | | | | |
| H₂ | 73.7 | 73.7 | 59.4 | 59.4 | 59.4 | 69.1 | — | N.A. | N.A. |
| [vol. %] | | | | | | | | | |
| CO | — | — | 14.3 | 14.3 | 14.3 | 16.7 | — | N.A. | N.A. |
| [vol. %] | | | | | | | | | |
| H₂O | — | — | 14.3 | 14.3 | 14.3 | 0 | 100 | N.A. | N.A. |
| [vol. %] | | | | | | | | | |
| H₂/CO₂ | 2.8 | 2.8 | 5.0 | 5.0 | 5.0 | 5.0 | — | N.A. | N.A. |
| H₂/CO | — | — | 4.1 | 4.1 | 4.1 | 4.1 | — | N.A. | N.A. |
| XCO₂¹ [%] | — | — | 54 | 54 | 54 | 54 | — | N.A. | N.A. |

¹XCO₂ = % conversion of CO₂, based on feed stream 10.

### Example 4 (Comparative)

In comparative Examples 2 and 3 the composition of the feed stream 10 was kept the same as in Example 1. Due to lower conversion in examples 2 and 3, the H₂/CO ratio in the product stream 100 appeared unfavourable. In this comparative Example 4, the H₂/CO₂ of the feed stream was adjusted to obtain the same H₂/CO ratio for the stream 100 as in Example 1. Therefore, in this comparative example, a set of calculations was performed (again using the same UniSim software) , whilst—like in Example 3—again using the line-up of FIG. 1 and also without the presence of the CO₂ removal unit 8 (and hence also without combining the CO₂-enriched stream 120 as obtained in a CO₂ removal unit 8 with the feed stream 10), and the composition for the feed stream 10 was adapted to arrive at the same H₂/CO ratio (viz. 1.9) for the water-depleted syngas stream 100. The same temperature was used for the syngas containing stream 30 (viz. 550° C.) as in FIG. 1/Table 1 according to the present invention.

Table 4 below shows the compositions and conditions of the streams in the various flow lines.

As can be seen from Table 4, to arrive at the same H₂/CO ratio (viz. 1.9) for the water-depleted syngas stream 100 as in FIG. 1/Table 1 according to the present invention, the H₂/CO₂ ratio for the feed stream 10 needed to be significantly lowered (from 2.8 in Table 1 to 1.0 in Table 4).

A drawback of such a low H₂/CO₂ ratio for the feed stream 10 is that the equilibrium conversion is lowered even further (viz. 36%).

TABLE 4
Comparative. - no CO₂ removal unit 8. Same
H₂/CO ratio for the water-depleted syngas stream 100

| stream | 10 | 20 | 30 | 40 | 50 | 100 | 110 | 120 | 130 |
|---|---|---|---|---|---|---|---|---|---|
| T [° C.] | 25 | 480 | 550 | 160 | 40 | 40 | 40 | N.A. | N.A. |
| CO₂ | 49 | 49 | 31.5 | 31.5 | 31.5 | 38.1 | — | N.A. | N.A. |
| [vol. %] | | | | | | | | | |
| H₂ | 51 | 51 | 33.5 | 33.5 | 33.5 | 40.5 | — | N.A. | N.A. |
| [vol. %] | | | | | | | | | |
| CO | — | — | 17.5 | 17.5 | 17.5 | 21.1 | — | N.A. | N.A. |
| [vol. %] | | | | | | | | | |
| H₂O | — | — | 17.5 | 17.5 | 17.5 | 0 | 100 | N.A. | N.A. |
| [vol. %] | | | | | | | | | |
| H₂/CO₂ | 1.0 | 1.0 | 1.1 | 1.1 | 1.1 | 1.1 | — | N.A. | N.A. |
| H₂/CO | — | — | 1.9 | 1.9 | 1.9 | 1.9 | — | N.A. | N.A. |
| XCO₂¹ [ %] | — | — | 36 | 36 | 36 | 36 | — | N.A. | N.A. |

¹XCO₂ = % conversion of CO₂, based on feed stream 10.

### Example 5 (comparative)

In this comparative example, being a variant of Example 4, a further set of calculations was performed (again using the same UniSim software). As in Examples 3 and 4, the same line-up of FIG. 1 was used, again without the presence of the CO₂ removal unit 8 (and hence also without combining the CO₂-enriched stream 120 as obtained in a CO₂ removal unit 8 with the feed stream 10).

In this Example 5, the same composition for the feed stream 10 (with a H₂/CO₂ ratio of 2.8) as used in Example 1 and Example 3 was used, but the temperature of the syngas containing stream 30 obtained at the outlet of the RWGS reactor composition was adapted (rather than adapting the composition for the feed stream 10 as done in Example 4). This, to try to arrive at the same overall CO₂ conversion (viz. 97%) and hence also at the same H₂/CO ratio (viz. 1.9) for the water-depleted syngas stream 100 as in FIG. 1/Table 1 according to the present invention.

Table 5 below shows the compositions and conditions of the streams in the various flow lines.

As can be seen from Table 5, the H₂/CO₂ ratio for the feed stream 10 needed was kept the same as in Tables 1 and 3 (viz. 2.8), but the temperature in the RWGS reactor was allowed to increase to try to arrive at the same H₂/CO ratio (viz. 1.9) for the water-depleted syngas stream 100 as in FIG. 1/Table 1 according to the present invention. However, already with a relatively high temperature of 750° C. for the syngas containing stream 30, the H₂/CO ratio for the water-depleted syngas stream 100 was still well above 1.9 (viz. 3.0), because the overall CO₂ conversion is still well below the 97% of Example 1 (viz. 70%).

TABLE 5
Comparative - no CO₂ removal unit 8. Higher
temperature for syngas containing stream 30

| stream | 10 | 20 | 30 | 40 | 50 | 100 | 110 | 120 | 130 |
|---|---|---|---|---|---|---|---|---|---|
| T [° C.] | 25 | 650 | 750 | 163 | 40 | 40 | 40 | N.A. | N.A. |
| CO₂ | 26.3 | 26.3 | 7.8 | 7.8 | 7.8 | 9.5 | — | N.A. | N.A. |
| [vol. %] | | | | | | | | | |
| H₂ | 73.7 | 73.7 | 55.1 | 55.1 | 55.1 | 67.6 | — | N.A. | N.A. |
| [vol. %] | | | | | | | | | |
| CO | — | — | 18.5 | 18.5 | 18.5 | 22.7 | — | N.A. | N.A. |
| [vol. %] | | | | | | | | | |
| H₂O | — | — | 18.5 | 18.5 | 18.5 | 0 | 100 | N.A. | N.A. |
| [vol. %] | | | | | | | | | |
| H₂/CO₂ | 2.8 | 2.8 | 7.1 | 7.1 | 7.1 | 7.1 | — | N.A. | N.A. |
| H₂/CO | — | — | 3.0 | 3.0 | 3.0 | 3.0 | — | N.A. | N.A. |
| XCO₂¹ [%] | — | — | 70 | 70 | 70 | 70 | — | N.A. | N.A. |

¹XCO₂ = % conversion of CO₂, based on feed stream 10.

### Discussion

As can be seen from the above Examples, the method according to the present invention allows for an effective way of producing syngas using a single stage, catalytic RWGS reaction, whilst maintaining the temperature in the RWGS reactors below 700° C. and whilst still achieving desirable CO₂ conversion (of above 95%), with just 1 RWGS stage.

The person skilled in the art will readily understand that many modifications may be made without departing from the scope of the invention.

1.-9. (canceled)

10. A method for producing syngas using a catalytic reverse water gas shift (RWGS) reaction, the method at least comprising the steps of:
a) providing a feed stream comprising at least hydrogen (H₂) and carbon dioxide (CO₂);
b) heating the feed stream provided in step a) in a first heat exchanger thereby obtaining a first heated feed stream;
c) introducing the first heated feed stream into a RWGS reactor and subjecting it to a catalytic RWGS reaction in the presence of a non-methanation promoting catalyst wherein the pressure as used in the RWGS reactor in step c) is above 20 bara and wherein the temperature as used in the RWGS reactor in step c) is in the range of from 450 to 700° C., thereby obtaining a syngas containing stream, wherein the syngas containing stream comprises at most 1.0 vol. % methane (CH₄);
d) cooling the syngas containing stream obtained in step c) in the first heat exchanger against the feed stream provided in step a), thereby obtaining a first cooled syngas stream;
e) cooling the first cooled syngas stream obtained in step d) in a second heat exchanger thereby obtaining a second cooled syngas stream;
f) separating the second cooled syngas stream obtained in step e) in a gas/liquid separator thereby obtaining a water-enriched stream and a water-depleted syngas stream;
g) separating the water-depleted syngas stream obtained in step f) in a CO₂ removal unit thereby obtaining a CO₂-enriched stream and a CO₂-depleted syngas stream, wherein the CO₂-depleted syngas stream has a hydrogen to carbon monoxide (H₂/CO) volume ratio in the range of 1.5 to 2.5; and
h) combining the CO₂-enriched stream obtained in step g) with the feed stream provided in step a).

11. The method according to claim 10, wherein the first heated stream obtained in step b) has a hydrogen to carbon dioxide (H₂/CO₂) volume ratio of below 2.0.

12. The method according to claim 10, wherein the first heated stream obtained in step b) has a hydrogen to carbon dioxide (H₂/CO₂) volume ratio of below 1.5.

13. The method according to claim 10, wherein the first heated stream obtained in step b) has a hydrogen to carbon dioxide (H₂/CO₂) volume ratio of below 1.2.

14. The method according to claim 10, wherein the RWGS reactor comprises a multi-tubular reactor heated by molten salt circulating around the tubes of the multi-tubular reactor.

15. The method according to claim 14 wherein the circulating being in counter-current operation.

16. The method according to claim 10, wherein the catalyst as used in the catalytic RWGS reaction in step c) comprises cerium oxide, zirconium oxide or a combination thereof.

17. The method according to claim 10, wherein the syngas containing stream obtained in step c) comprises at most 0.1 vol. % methane.

18. The method according to claim 10, wherein the temperature of the syngas containing stream obtained in step c) is kept below 700° C.

19. The method according to claim 10, wherein the temperature of the syngas containing stream obtained in step c) is kept below 650° C.

20. The method according to claim 10, wherein the temperature of the syngas containing stream obtained in step c) is kept below 600° C.

21. The method according to claim 10, wherein the CO₂-depleted syngas stream obtained in step g) comprises at most 10 vol. % CO₂.

22. The method according to claim 10, wherein the CO₂-depleted syngas stream obtained in step g) comprises at most 5 vol. % CO₂.

23. The method according to claim 10, wherein the CO₂-depleted syngas stream obtained in step g) comprises at most 2 vol. % CO₂.
